(19) United States
(12) Patent Application Publication
(10) Pub. No.: US 2016/0109583 A1
(43) Pub. Date: Apr. 21, 2016

(54) METHOD OF DETERMINING LOCATION OF MACHINE

(71) Applicant: Caterpillar Inc., Peoria, IL (US)

(72) Inventor: Frank Willis, Canton, IL (US)

(73) Assignee: Caterpillar Inc., Peoria, IL (US)

(21) Appl. No.: 14/981,971

(22) Filed: Dec. 29, 2015

(51) Int. Cl. G01S 19/47

(52) U.S. Cl. CPC G01S 19/47

(57) ABSTRACT

A method of determining a location of a machine is provided. The method includes determining a location of the machine based on the signals received from an IMU at each of a plurality of unit time. The method also includes determining a location of the machine corresponding to a first unit time based on signals received from the satellite positioning unit at a second unit time. The method includes determining an error associated with the location of the machine, by a processing unit, based on the location determined by the satellite positioning unit and the location determined based on the signals received from the IMU at a unit time successive to the first unit time. The method also includes adding the error to the location of the machine determined based on the signals received from the IMU at a successive unit time to the second unit time.

### TECHNICAL FIELD

The present disclosure relates to a method of locating a machine, and more particularly to a system and a method of determining a location of a machine.

### BACKGROUND

Machines, such as trucks, dozers, excavators, and drill machines, are operated to perform various operations at a worksite. Generally, a location of the machine at the worksite is determined using a positioning system. The positioning system includes a Global Positioning System (GPS)/Global Navigation Satellite System (GNSS), and Inertial Measurement Unit (IMU). The positioning system combines information from the GPS/GNSS and IMU to determine a position and an orientation of the machine at the worksite. The position and the orientation of the machine determined using the positioning system includes an error due to factors such as modes of information transfer and the like. Hence, the positioning system implements various mechanisms such as filters and controllers to mitigate the error in the determined location of the machine to detect an actual location of the machine.

U.S. Pat. No. 6,721,657, hereinafter referred to as the '657 patent, describes an inertial GPS navigation system. The inertial GPS navigation system includes a receiver. The receiver uses a single processor to control a GPS sub-system and an inertial (“INS”) sub-system and, through software integration, shares GPS and INS position and covariance information between the sub-systems. The receiver time tags the INS measurement data using a counter that is slaved to GPS time. The receiver further uses separate INS and GPS filters to produce GPS and INS position information that is synchronized in time. The GPS/INS receiver utilizes GPS position and associated covariance information in the updating of an INS Kalman filter. The Kalman filter provides updated system error information that is used in propagating inertial position, velocity and attitude. Whenever the receiver is stationary after initial movement, the INS sub-system performs “zero-velocity updates,” to more accurately compensate in the Kalman filter for component measurement biases and measurement noise. Further, if the receiver loses GPS satellite signals, the receiver utilizes the inertial position, velocity and covariance information provided by the Kalman filter in the GPS filters, to speed up GPS satellite signal re-acquisition and associated ambiguity resolution operations. However, the '657 patent does not disclose a method of determining the location of the machine based on error estimates associated with the signals received from the positioning system.

### SUMMARY OF THE DISCLOSURE

In one aspect of the present disclosure, a method of determining a location of a machine is provided. The method includes receiving signals from an Inertial Measurement Unit (IMU) at each of a plurality of unit time. The method also includes determining a location of the machine based on the signals received from the IMU. The method includes triggering a satellite positioning unit of the machine at a first unit time. The method further includes determining a location of the machine corresponding to the first unit time based on signals received from the satellite positioning unit at a second unit time. The method includes determining an error associated with the location of the machine, by a processing unit, based on the location determined by the satellite positioning unit and the location determined based on the signals received from the IMU at a unit time successive to the first unit time. The method also includes adding the error to the location of the machine determined based on the signals received from the IMU at a successive unit time to the second unit time.

Other features and aspects of this disclosure will be apparent from the following description and the accompanying drawings.

### BRIEF DESCRIPTION OF THE DRAWINGS

FIG. 1 is a schematic side view of an exemplary worksite and a machine operating at the worksite, according to an embodiment of the present disclosure;

FIG. 2 is a block diagram of a positioning system for determining a location of the machine at the worksite;

FIG. 3 is a schematic diagram illustrating a method of determining the location of the machine at the worksite;

FIG. 4 is a graphic representation showing the location of the machine determined using the positioning system at a number of unit time; and

FIG. 5 is a flowchart for a method of determining the location of the machine at the worksite.

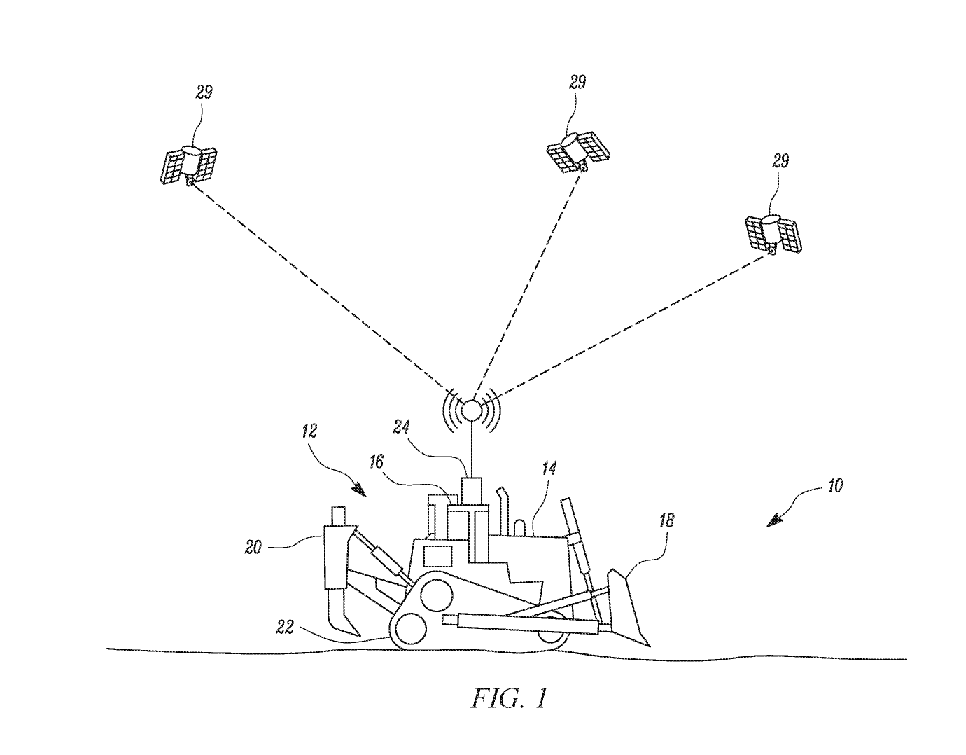

### DETAILED DESCRIPTION

Wherever possible, corresponding or similar reference numbers will be used throughout the drawings to refer to the same or corresponding parts. FIG. 1 illustrates a schematic side view of a worksite 10 and a machine 12 operating at the worksite 10. The worksite 10 may include a mining site, a landfill, a quarry, a construction site, a road worksite, a forest, a farm, or any other worksite, without any limitations. In the illustrated embodiment, the machine 12 is a dozer. The dozer may perform a ripping operation and/or a cutting operation at the worksite 10. In other embodiments, the machine 12 may be an on-highway vehicle or an off-highway vehicle, such as an excavator, a backhoe, a loader, a motor grader, or any other wheeled or tracked vehicle that may be used for performing various operations. The operations may include a dozing operation, a grading operation, a leveling operation, a bulk material removal operation, or any other type of operation. Further, the machine 12 may operate in an autonomous mode, a semi-autonomous mode, or a manual mode.

The machine 12 includes a frame 14 for supporting various components of the machine 12 including an operator cab 16, a cutting tool 18, and a ripping tool 20. The operator cab 16 may include multiple control levers and/or switches for controlling movement of the machine 12 and the ripping and cutting operations of the machine 12. The machine 12 also includes a pair of tracks 22 to engage with a work surface and to move the machine 12 along the work surface to perform the ripping and cutting operations. The tracks 22 may be supported on the frame 14 and may receive driving power from a power source, such as an engine (not shown), to move the machine 12 at the worksite 10. It may also be contemplated that the machine 12 may include a number of wheels to engage with the work surface. The power source may be disposed at any location on the machine 12 to supply power to various systems of the machine 12. Further, a hydraulic system of the machine 12 may be in fluid communication with the cutting and ripping tools 18, 20 for performing the cutting and ripping operations, respectively.

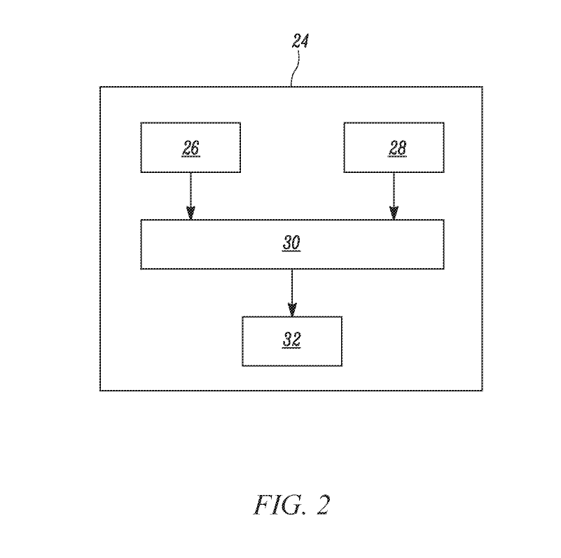

The positioning system 24 determines a location of the machine 12 at the worksite 10. Referring to FIGS. 1 and 2, the positioning system 24 includes an Inertial Measurement Unit (IMU) 26 disposed in the machine 12. The IMU 26 may include a number of sensors. The number of sensors may include accelerometers and/or gyroscopes. The number of sensors may generate signals indicative of various positional attributes of the machine 12, such as a change in the velocity of the machine 12, a change in the attitude/orientation of the machine 12, and a change in the path of travel of the machine 12, without limiting the scope of the present disclosure. Further, the IMU 26 determines the acceleration of the machine 12 based on the signals generated by the sensors of the IMU 26. In some examples, the IMU 26 also determines changes in rotational attributes of the machine 12 such as, pitch, roll, and yaw. The determined acceleration of the machine 12 and/or the changes in rotational attributes of the machine 12 are integrated with an initial known position of the machine 12 to determine a current position of the machine 12 at a unit time “tₙ”. Alternatively, the IMU 26 may include any other means that assists in determination of the location of the machine 12, without any limitations.

The positioning system 24 also includes a satellite positioning unit 28 disposed on the machine 12. The satellite positioning unit 28 generates signals indicative of the location of the machine 12 at the worksite 10. In one example, the satellite positioning unit 28 may determine and generate signals corresponding to the latitude and/or longitude of the machine 12 at the worksite 10. In the illustrated embodiment, the satellite positioning unit 28 includes a Global Positioning Satellite (GPS)/Global Positioning System (GPS)/Global Navigation Satellite System (GNSS) receiver. The satellite positioning unit 28 may be disposed on a top portion of the machine 12 to communicate with a number of satellites 29 and to receive signals indicative of the location of the machine 12 at the worksite 10. In one example, the satellite positioning unit 28 is disposed on top of the operator cab 16 to receive signals from the satellites 29 without interfering with any components present in a surrounding of the machine 12. In other embodiments, the satellite positioning unit 28 may be disposed at any location on the machine 12 to receive signals from the satellites 29 without any obstruction.

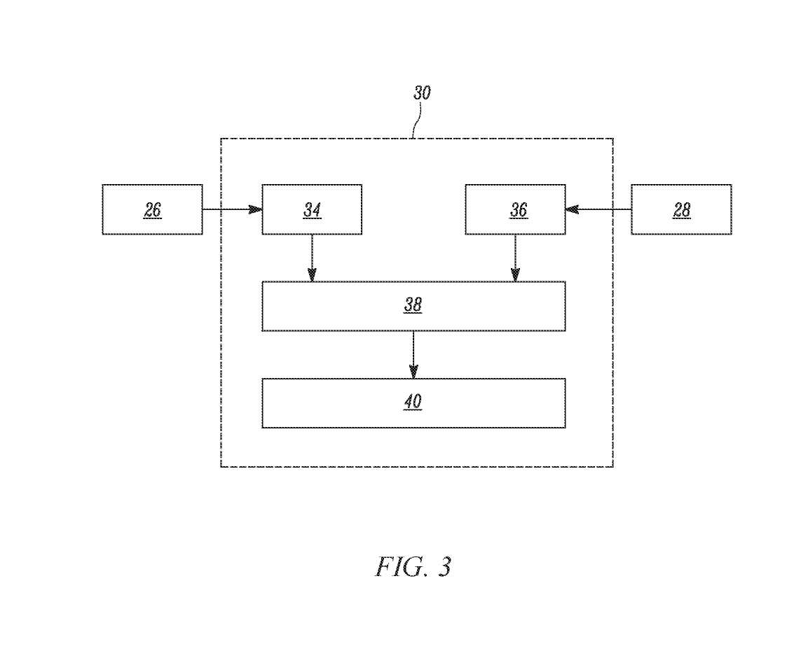

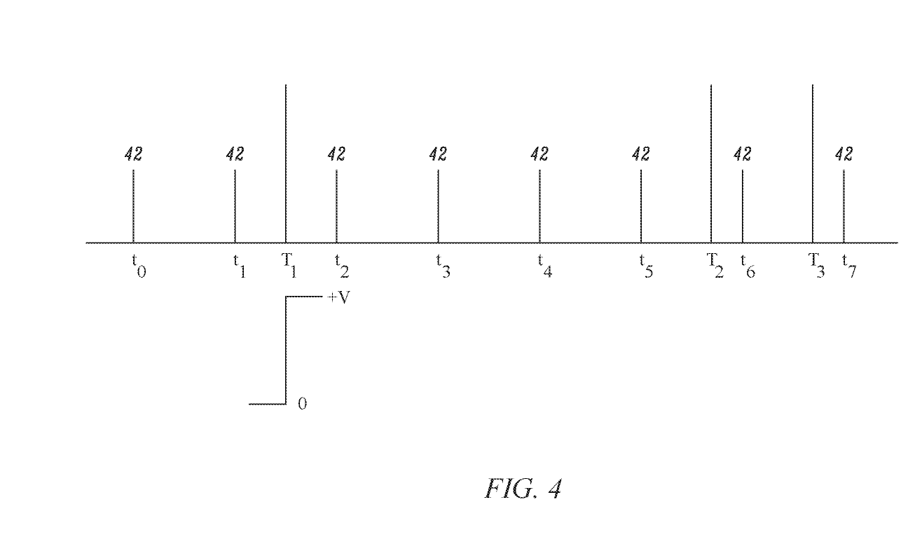

The positioning system 24 further includes a processing unit 30. The processing unit 30 is in communication with the satellite positioning unit 28 and the IMU 26, and receives signals therefrom. The processing unit 30 may embody an embedded control system. FIG. 3 is a schematic diagram illustrating a process that may be stored in and implemented by the processing unit 30 in order to determine the location of the machine 12. At step 34, the processing unit 30 receives signals indicative of the location of the machine 12 from the IMU 26. Based on the signals received from the IMU 26, the processing unit 30 may determine the location of the machine 12. As shown in FIG. 4, the processing unit 30 may receive signals 42 corresponding to the location of the machine 12 at a number of unit time “t₀”, “t₁”, “t₂”, “t₃”, “t₄”, “t₅”, “t₆”, and “t₇”. If the machine 12 is operating from time “t₀” to “t₇”, the IMU 26 sends the signals 42 to the processing unit 30 at each time interval in between time “t₀” to “t₇”.

Referring now to FIG. 3, the processing unit 30 is also in communication with the satellite positioning unit 28. At step 36, the processing unit 30 receives signals from the satellite positioning unit 28 indicative of the location of the machine 12 at the worksite 10. In order to determine the location of the machine 12, the satellite positioning unit 28 is triggered at a first unit time “T1”. The satellite positioning unit 28 generates a pulse indicative of the position of the machine 12. In one example, the pulse may be a TTL level pulse. The satellite positioning unit 28 sends signals indicative of the location of the machine 12 at the time of the pulse. In the illustrated example, the first unit time lies between “t₁” and “t₂”. In some situations, the processing unit 30 experiences a delay in receiving the signals indicative of the location of the machine 12 from the satellite positioning unit 28. In one example, the delay may simply be due to the time needed to transmit the data. This may cause the signals indicative of the location of the machine 12 to arrive at a later time. The unit time at which the processing unit 30 receives the signals indicative of the location of the machine 12 at the first unit time “T1” from the satellite positioning unit 28 is defined as a second unit time “T2”. In the illustrated example, the second unit time “T2” lies between “t₅” and “t₆”.

The processing unit 30 (see FIGS. 2 and 3) of the present disclosure includes a Kalman filter module (not shown). The Kalman filter module is a tool that can estimate multiple state variables for a wide range of processes. The Kalman filter module is implemented in the processing unit 30 to estimate multiple state variables associated with the machine 12 for determining the location of the machine 12. The state variables of the machine 12 may include, but are not limited to, the errors in the latitude and/or the longitude of the machine 12. The Kalman filter module implemented in one example may be an Indirect Kalman Filter. In an Indirect Kalman Filter, the state variables are taken as errors in the values of interest, rather than the values themselves. For example, the Indirect Kalman Filter uses the error in latitude as the state variable rather than the latitude directly. In order to use an Indirect Kalman Filter to estimate the error in the location determined by the IMU 26, the machine 12 may be described by a linear system.

The Indirect Kalman Filter estimates error in the location, based on the signals 42 received from the IMU 26 and the satellite positioning unit 28. The Indirect Kalman Filter combines the signals 42 indicative of the location of the machine 12 from the IMU 26 at a successive unit time “t₂” to the first unit time “T1” and the satellite positioning unit 28. The error estimated by the Indirect Kalman Filter is added to the location determined using the signals 42 received from the IMU 26 at a successive unit time to the second unit time “T2”. In one example, the error determined by the Indirect Kalman Filter is added to the location at a third unit time “T3”.

The positioning system 24 also includes an output device 32. The output device 32 may embody any visual output device or an audio output device known in the art. The output device 32 is communicably coupled to the processing unit 30. The output device 32 provides the location of the machine 12 at the worksite 10 as determined by the processing unit 30. The output device 32 may be present in the machine 12, at the worksite 10, or at a remote base station, as per requirements.

### INDUSTRIAL APPLICABILITY

The present disclosure relates to the positioning system 24 and a method 44 of determining the location of the machine 12. The positioning system 24 implements the Indirect Kalman Filter, which determines the error in the location of the machine 12 based on the signals 42 received from the IMU 26 and the satellite positioning unit 28 at the second unit time “T2”. The error is applied to the location at a time “T3” subsequent to time “T2”. The method 44 of the present disclosure does not store any previous locations of the machine 12 for applying the correction, hence the usage of memory is less compared to other conventional methods known in the art.

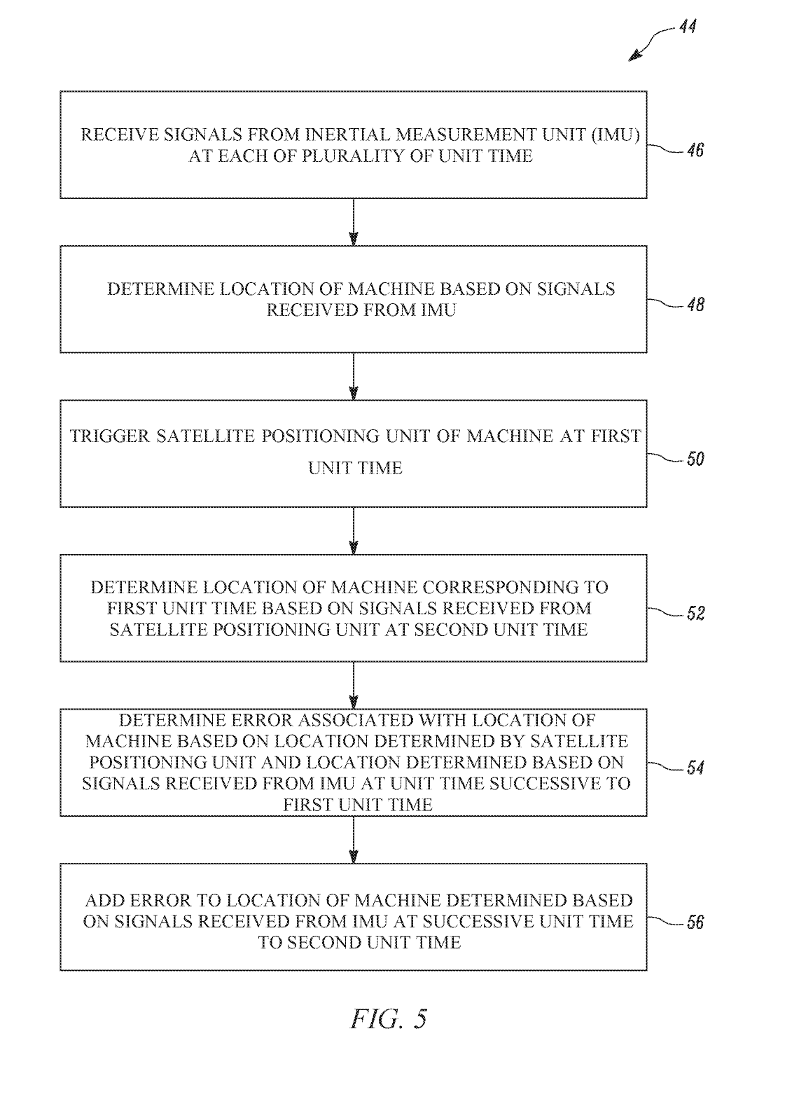

FIG. 5 is a flowchart of an example for the method 44 of determining the location of the machine 12 at the worksite 10. At step 46, the processing unit 30 receives signals 42 from the IMU 26 at each of the number of unit time “t₀”, “t₁”, “t₂”, “t₃”, “t₄”, ‘t₅”, “t₆”, “t₇”. At step 48, the location of the machine 12 is determined by the processing unit 30 based on the signals 42 received from the IMU 26. At step 50, the satellite positioning unit 28 is triggered at the first unit time.

At step 52, the location of the machine 12 is determined by the processing unit 30 corresponding to the first unit time “T1” based on the signals received from the satellite positioning unit 28 at the second unit time “T2”. At step 54, the error associated with the location of the machine 12 is determined by the processing unit 30. The error is determined based on the location determined by the satellite positioning unit 28 and the location determined based on the signals received from the IMU 26 at the unit time “t₂” successive to the first unit time “T1”. At step 56, the error is added to the location of the machine 12 based on the signals received from the IMU 26 at the third unit time “T3” successive to the second unit time “T2”.

In an example, the processing unit 30 receives the signals 42 from the IMU 26 at each of the unit times “t0”, “t1”, and the location of the machine 12 is determined by the processing unit 30 based on the signals 42 received from the IMU 26. Also, the satellite positioning unit 28 is triggered based on the pulse received at the first unit time, “T1”. Further, the processing unit 30 also receives the signals 42 from the IMU 26 at each of the unit times “t2”, “t3”, “t4”, “t5”, and the location of the machine 12 is determined by the processing unit 30 based on the signals 42 received from the IMU 26. The location of the machine 12 is determined by the processing unit 30 corresponding to the first unit time “T1” based on the signals received from the satellite positioning unit 28 at the second unit time “T2”. The processing unit 30 receives signals 42 from the IMU 26 at the unit time “t6”, and the location of the machine 12 is determined by the processing unit 30 based on the signals 42 received from the IMU 26.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of determining a location of a machine, the method comprising:
receiving signals from an Inertial Measurement Unit (IMU) at each of a plurality of unit time;
determining a location of the machine based on the signals received from the IMU;
triggering a satellite positioning unit of the machine at a first unit time;
determining a location of the machine corresponding to the first unit time based on signals received from the satellite positioning unit at a second unit time;
determining an error associated with the location of the machine, by a processing unit, based on the location determined by the satellite positioning unit and the location determined based on the signals received from the IMU at a unit time successive to the first unit time; and
adding the error to the location of the machine determined based on the signals received from the IMU at a successive unit time to the second unit time.
